(19) United States
(12) Patent Application Publication
(10) Pub. No.: US 2019/0136609 A1
(43) Pub. Date: May 9, 2019

(54) Sealing Device for a Sliding Door

(71) Applicant: Planet GDZ AG, Tagelswangen (CH)

(72) Inventors: Andreas Dintheer, Illnau (CH); René Fässler, Zurich (CH)

(73) Assignee: Planet GDZ AG, Tagelswangen (CH)

(21) Appl. No.: 16/096,486

(22) PCT Filed: May 4, 2017
(86) PCT No.: PCT/EP2017/060688

§ 371 Date: Oct. 25, 2018

(30) Foreign Application Priority Data
May 4, 2016 (EP) PCT/EP2016/060038
Apr. 21, 2017 (EP) 17167623.2

(51) Int. Cl. E06B 7/21; E06B 7/23

(52) U.S. Cl. CPC E06B 7/21; E06B 7/2316

(57) ABSTRACT

A sealing device of a sliding door with a displaceably mounted door leaf has a lowering seal with a sealing strip and with an actuating mechanism for automatically lowering and raising the sealing strip. The sealing device has an activating unit for activating the lowering seal, wherein the activating unit has a first contact surface, a pivotably designed contact element and a pivotably designed force transmission element. Upon closing of the door leaf, the contact element contacts the first contact surface and moves, during the closing movement of the door leaf, with pivoting of the contact element, along the first contact surface. A pivoting movement of the contact element results in a pivoting movement of the force transmission element, with the result that the latter actuates the lowering seal.

### TECHNICAL FIELD

The present invention relates to a sealing device for a sliding door.

### PRIOR ART

Drop-down seals are used for sealing doors and windows. Said drop-down seals prevent light from passing through and offer an acoustic protection as well as a protection against draft and smoke. In the case of external doors, said drop-down seals moreover serve as splash protection in the event of rain, and depending on the embodiment can also protect against flooding.

Lowerable door and window seals are usually composed substantially of a housing in the form of a hat-shaped or U-shaped profiled rail that is open toward the bottom, a sealing strip that is held so as to be liftable and lowerable in said housing, said sealing strip having a sealing profile as well as an activation mechanism for lifting and lowering the sealing strip. The activation mechanism in proven drop-down seals has leaf springs which at a first location are fastened to the housing, at a second position fastened to the sealing strip, and at a third location fastened to a slide. The slide usually transitions to an activation button which projects from the housing on one side or both sides. In the closing of the door, the activation button on the door frame is depressed, and the sealing strip is automatically lowered counter to the spring force of the leaf springs and is pressed in a sealing manner against the floor. The activation button is released again in the opening of the door, and the sealing strip is automatically lifted. Further types of activation mechanisms, for example lever assemblies, are known. Door seals of this type are known, for example, from EP 0 338 974, DE 299 16 090, and EP 0 509 961. EP 2 085 559 discloses an automatically lowerable sealing device in which the activation mechanism is activated by the influence of lateral force.

EP 2 476 857 discloses a drop-down seal for sliding doors. The drop-down seal is embodied as described above, and has an activation button that projects from the seal housing. The door frame in the region of the secondary closing edge has a detent element having a downwardly inclined oblique face and a receptacle pocket that runs in a straight line. In the closing of the door leaf, a first roller that is attached to the door leaf runs along said oblique face and herein pulls downward a spring-loaded slide. A second roller that is disposed on the slide pushes a lever onto the activation button which, on account thereof, activates the activation mechanism and lowers the sealing strip. In the further closing of the door leaf, the first roller makes its way into the receptacle pocket, and the lowering movement is stopped. The door leaf is fully closed in this state. Thanks to the receptacle pocket, the drop-down seal remains in the closed position without further blocking installations being necessary. The roller is guided back out of the receptacle pocket only when the door leaf is opened, this enabling automatic lifting of the sealing strip. This assembly has the disadvantage that a relatively great effort in terms of force is necessary by the user in the closing of the door, because the slide has to be lowered counter to the spring force and to the resistance of the lever that pushes onto the activation button. It is also disadvantageous that the automatic lifting of the slide in the opening of the door leads to the door being opened in a self-acting manner, the user thus not keeping full control in the opening action. A further disadvantage is that the slide in the running direction of the sliding door is disposed behind the drop-down seal such that the sealing strip has to be configured in a shortened manner and cannot completely seal in the region of the secondary closing edge. Furthermore, the terminal position permits little play such that a precise guiding of the door leaf and a precise positioning of all elements are mandatory.

Drop-down seals having an activation button that is activatable on the end side have proven successful in practice for pivotable door leafs. The force transmission ratio in the closing of the door leaf, without any further mechanisms, is already approximately 1:30, such that the activation button in the closing of the door leaf can be depressed without a noticeable effort in terms of force. The use of drop-down seals of this type for sliding doors is more problematic since the transmission of force onto the activation button is only 1:1 and thus more force has to be applied in order for the activation button to also be depressed in the closing of the door leaf.

### SUMMARY OF THE INVENTION

It is therefore an object of the invention to achieve an improved sealing device for sliding doors.

This object is achieved by a sealing device having the features of patent claim 1, and by each of the sealing devices having the features of patent claims 16, 17, and 18.

The sealing device of a sliding door having a displaceably mounted door leaf has a drop-down seal having a sealing strip and having an activation mechanism for automatically lowering and lifting the sealing strip. The lowering is performed counter to a restoring force. The sealing device has an activation unit for activating the drop-down seal, wherein the activation unit has a first contact face, a pivotably configured contact element, and a pivotably configured force transmission element. The contact element in the closing of the door leaf contacts the first contact face and in the closing movement of the door leaf moves along the first contact face while pivoting the contact element. A pivoting movement of the contact element results in a pivoting movement of the force transmission element, on account of which the force transmission element activates the drop-down seal.

Terms such as “upward” and “downward” in this text describe directions in which the sealing strip of the drop-down seal moves. “Upward” is thus the direction in which the sealing strip is lifted and is retracted into the housing rail thereof; “downward” is the direction in which the sealing strip for the purpose of sealing the door gap is lowered, thus deployed from the housing rail of said sealing strip. The direction “downward” preferably describes the direction of the force of gravity, thus toward a floor a of a building. Cases in which the direction of gravity is referred to are indicated in the text.

Where contacting by way of a contact face is discussed hereunder, the respective contact can be punctiform or linear and need not be planar.

According to the invention, the second contact face of the contact element moves, preferably rolls, along the first contact face in a sliding manner. When said contact face rolls along, said contact face thus unrolls along the first contact face, and each point of the first contact face is contacted by another point of the second contact face.

The force to be applied in the closing of the door is thus minimized, wherein the design embodiment of the two contact faces and the position of the first pivot axis can be chosen such that an optimal transmission of force for lowering the sealing strip can be achieved.

The first contact face is preferably directed upward, and the contact element in the closing of the door leaf bears on said first contact face, wherein said contact element slides, preferably rolls, along the latter, and on account thereof activates the drop-down seal. The directional indication “upward” in this context preferably refers to the direction that is counter to the force of gravity.

The first contact face that is directed upward (taking into consideration the direction of the force of gravity) has the advantage that the weight of the door leaf in part or in full pushes onto the contact element. A person closing the sliding door has to apply comparatively little or no additional force at all in order for the sealing strip to be lowered. Despite the drop-down seal, the sliding door can be closed without an increased effort in terms of force.

The contact element is preferably connected or operatively connected to the activation mechanism. Said contact element per se can also be a component part of the activation mechanism.

The first contact face and the contact element are preferably configured such that a force that acts upward, preferably acts counter to the force of gravity, is maintained in the closing of the door leaf, said force being deflected in such a manner that said force acts on the activation mechanism.

The assembly according to the invention is preferably disposed on the side of the secondary closing edge of the sliding door. However, said assembly according to the invention can also be disposed on the primary closing edge.

The activation unit, like the activation mechanism, is preferably composed exclusively of mechanical means and preferably does not comprise any magnets and/or electric motors and/or sensors.

Since the first contact face in the sliding direction can be disposed beside the drop-down seal, the sealing strip can extend across the entire length of the door leaf, and said sealing strip can thus seal in an optimal manner.

A further advantage is that the activation unit holds the sealing strip in a lowered position without the restoring force influencing any sliding movement of the door leaf in the longitudinal direction of the sealing strip. On account thereof, no additional blocking mechanisms are necessary in order for the door leaf to be held in the closed position thereof.

Furthermore, the restoring force of the drop-down seal does not impede the complete closing of the sliding door. Due to the large weight of sliding doors, many sliding doors have a brake mechanism which decelerates the closing movement of the door leaf shortly before the completely closed position is reached. It is prevented on account thereof that fingers or other parts of the body are excessively jammed. In preferred embodiments of the invention, this brake mechanism is not to be influenced by the restoring force of the drop-down seal, or by the force required for lowering the seal, respectively. Additionally or alternatively, the intention is also that not more force has to be applied for closing the door. Therefore, the drop-down seal in these embodiments can be fully lowered already before the completely closed position is reached and be held in this position without any further effort in terms of external force. The sealing strip in the continuing closing movement does indeed scrape along the floor but only across a short distance.

This “zero force” position can be achieved in various ways. A position of the contact element on the first contact face in which position the sealing strip is fully lowered and in which position the restoring force acting on the sealing strip is deflected in a direction perpendicular to the longitudinal direction of the sealing strip is preferably present.

The first contact face in the longitudinal direction of the drop-down seal preferably at least in part runs in an oblique direction, wherein said first contact face in the closing direction of the door leaf preferably runs from bottom to top. The gradient can be consistent or variable. The force that has to be applied for lowering the sealing strip can be set by means of the gradient.

Force gear ratios for optimizing the force to be applied can thus be chosen.

The first contact face preferably has a horizontally running portion on which the contact element bears so as to hold the sealing strip in the lowered position. The horizontal portion preferably adjoins the obliquely running portion. The door leaf can be completely closed in that the contact element first moves upward along the oblique face, herein lowering the sealing strip, and with the sealing strip lowered subsequently moves further along the horizontal face until the door leaf laterally contacts the door frame.

In preferred embodiments the contact element activates the activation mechanism in order for the sealing strip to be lowered. Said contact element can carry this out directly or indirectly, for example by means of a force transmission element.

The contact element is preferably fixedly connected to the drop-down seal, and the first contact face is configured in a module which is separate from the drop-down seal and which is intended for disposal in a locationally fixed part of the sliding door.

The second contact face across the entire length thereof is preferably configured so as to be curved. Said second contact face in alternative embodiments has one or a plurality of planar intermediate regions. Preferably, only the second contact face is configured so as to be curved, and the first contact face has a planar surface which runs so as to be oblique and/or horizontal.

The transmission of force can be set by way of the choice of gradient of the first contact face.

The first or the second contact face preferably has a length across which the contact element contacts or rolls, respectively, wherein the curvature of the first or second contact face has a curvature radius that varies across said length. The curved face preferably forms an involute.

The contact element is preferably pivotable about a first axis and the force transmission element is preferably pivotable about a second axis. The axes are preferably not identical. The first axis is preferably disposed so as to be perpendicular to the longitudinal direction of the drop-down seal and perpendicular to the lowering direction of the sealing strip, and the second axis runs so as to be parallel with the first axis.

The first axis is preferably disposed so as to be eccentric in relation to the second contact face in the contact element, wherein the contact element has a main body and a contacting arm disposed thereon, and wherein a free end of the contacting arm in the closing of the sliding door first contacts the first contact face. This optimizes the leverage and thus minimizes the effort in terms of force.

The force transmission element is preferably operatively connected to the contact element, wherein the force transmission element in the closing of the door leaf activates an activation button of the activation mechanism by way of a third contact face.

The force transmission element in the closing of the door leaf is preferably pivotable about the second axis. The second axis is preferably disposed so as to be eccentric in relation to the third contact face. The third contact face is preferably configured so as to be curved and preferably forms an involute.

Depending on the embodiment, the force transmission element and the contact element are operatively interconnected in different ways. Said force transmission element and said contact element can be interconnected by way of pivot axes and/or levers, for example. However, the contact element and the force transmission element preferably mesh with one another, said contact element and said force transmission element being in part configured in particular as gear wheels. This is a simple, space-saving and cost-effective type of force transmission. The main bodies of the contact element and of the force transmission element at least across part of the circumferences thereof are preferably configured as gear wheels.

The first axis is preferably disposed so as to be perpendicular to the longitudinal direction of the drop-down seal and perpendicular to the lowering direction of the sealing strip. The second axis preferably runs so as to be parallel with the first axis.

In preferred embodiments the force transmission element has a main body and a force transmission arm that is laterally offset in relation to the main body, wherein the force transmission arm activates the activation mechanism. The transmission arm preferably has the curved third contact face for contacting the lowering mechanism, in particular the activation button mentioned hereunder.

In preferred embodiments the activation mechanism of the drop-down seal has an activation button which activates the activation mechanism by way of the influence of external force. The contact element preferably acts indirectly or directly on said activation button and, on account thereof, lowers the sealing strip. Preferably, the force transmission element, more specifically the force transmission arm thereof, and even more specifically the third contact face, acts directly on said activation button. Since many known drop-down seals have an activation button of this type, the activation unit according to the invention can be used with these known drop-down seals without the latter having to be significantly modified.

The drop-down seal in preferred embodiments has a housing in which the sealing strip is held to as to be liftable and lowerable. The activation button can project from said housing at the end side. In other embodiments, said activation button is flush with the end side of the housing, or is disposed so as to be set back. The set-back arrangement is the most preferable. Said activation button in the longitudinal direction of the sealing strip is preferably displaceable relative to the housing.

The force transmission element preferably acts on said activation button at the end side, usually in that said force transmission element indirectly or directly depresses said activation button in the closing of the door and releases said activation button again in the opening of the door.

The activation unit according to the invention can also be used with other types of lowering mechanisms, wherein the contact element acts indirectly or directly on a suitable location of the drop-down seal.

The object set is also achieved by a sealing device of a sliding door having a displaceably mounted door leaf, which sealing device has a drop-down seal having a sealing strip and having an activation mechanism for automatically lowering and lifting the sealing strip, wherein the lowering is performed counter to a restoring force. The sealing device has an activation unit for activating the drop-down seal, wherein the activation unit has a contact element which in the closing of the door leaf contacts a first contact face of the activation unit and, on account thereof, activates the drop-down seal. The activation unit has a force transmission element. The contact element is configured so as to be pivotable about a first axis, and the force transmission element is configured so as to be pivotable about a second axis. The contact element and the force transmission element mesh with one another such that in the closing of the door leaf a pivoting movement of the contact element about the first axis results in a pivoting movement of the force transmission element about the second axis. The force transmission element in the closing of the door leaf by way of the pivoting movement of said force transmission element activates the drop-down seal.

Since the contact element and the force transmission element mutually engage like gear wheels, a space-saving and cost-effective configuration of the activation unit is possible, wherein the advantages of the contacting of a first contact face continue to be present, in particular when said first contact face is aligned upward and in particular when said first contact face has an obliquely running and a horizontal proportion. The contact element in the closing of the door leaf by way of a second contact face also here preferably slides, and more preferably rolls, along the first contact face. The features set forth above in the chapter “Summary of the Invention” and the features of the dependent patent claims can also be selectively combined with this device, without taking into consideration all features of claim 1, in order for the advantages already mentioned to be obtained.

The object set is furthermore also achieved by a sealing device of a sliding door having a displaceably mounted door leaf, which sealing device has a drop-down seal having a sealing strip and an activation mechanism for automatically lowering and lifting the sealing strip. The lowering is performed counter to a restoring force. The sealing device has an activation unit for activating the drop-down seal, wherein the activation unit has a contact element which in the closing of the door leaf contacts a first contact face of the activation unit and, on account thereof, activates the drop-down seal. The activation unit has a pivotable force transmission element which is operatively connected to the contact element. The force transmission element has a curved contact face which in the closing of the door leaf activates an activation button of the activation mechanism in order for the sealing strip to be lowered.

The curved configuration of the contact face enables an optimal transmission of force to the activation button, in particular when said contact face forms an involute and in particular when the pivot axis of the force transmission element is disposed so as to be eccentric to said contact face. This sealing device can also be combined with the features of the dependent claims, without using all features of claim 1.

The object set is furthermore also achieved by a sealing device of a sliding door having a displaceably mounted door leaf, which sealing device has a drop-down seal having a sealing strip and having an activation mechanism for automatically lowering and lifting the sealing strip. The lowering is performed counter to a restoring force. The sealing device has an activation unit for activating the drop-down seal, wherein the activation unit has a contact element which in the closing of the door leaf contacts a first contact face of the activation unit and, on account thereof, activates the drop-down seal. The contact element is configured so as to be pivotable about a first axis and has a second contact face which in the closing movement of the door leaf moves along the first contact face. Either the second contact face and/or the first contact face are/is configured so as to be curved. The second contact face in the closing movement preferably rolls along the first contact face. The first contact face at least across one region is preferably configured as an oblique face. The contact element in the closing movement is preferably pivoted about the first axis, on account of which the force for lowering the sealing strip is transmitted preferably to the lowering mechanism of the sealing strip. This sealing device can also be combined with the features of the dependent claims, without using all features of claim 1.

Further embodiments are set forth in the dependent claims. The features of the dependent claims, even without all features of patent claim 1, can be combined with the features of patent claims 16, 17, and 18,

An advantage of many of these embodiments is, in particular when a transmission of force by means of a gear wheel connection is chosen, that with the exception of the first contact face all elements for triggering and activating the seal can be disposed within the seal housing (housing rail with additional wall) without the seal housing having to be configured so as to be higher than in the case of classic drop-down seals.

### BRIEF DESCRIPTION OF THE DRAWINGS

Preferred embodiments of the invention will be described below on the basis of the drawings, which serve merely for explanation and are not to be interpreted as being restrictive. In the drawings:

FIG. 1 shows a view of a sealing device according to the invention from the front, having a lifted sealing strip, according to a first embodiment;

FIG. 2 shows a partial longitudinal section through the sealing device according to FIG. 1, having a lowered sealing strip, from a first side;

FIG. 3 shows a partial longitudinal section through the sealing device according to FIG. 1, having a lowered sealing strip, from a second side;

FIG. 4 shows a perspective illustration of part of the sealing device according to FIG. 2;

FIG. 5 shows a perspective illustration of part of the sealing device according to FIG. 3;

FIG. 6 shows a view of a sealing device according to the invention from the front, having a lowered sealing strip, according to a second embodiment;

FIG. 7 shows a partial longitudinal section through the sealing device according to FIG. 6, having a lifted sealing strip, from a first side;

FIG. 8 shows a partial longitudinal section through the sealing device according to FIG. 6, having a lifted sealing strip, from a second side;

FIG. 9 shows a perspective illustration of part of the sealing device according to FIG. 7;

FIG. 10 shows a perspective illustration of part of the sealing device according to FIG. 8;

FIG. 11 shows a partial longitudinal section through the sealing device according to FIG. 6, having a lowered sealing strip, from a first side;

FIG. 12 shows a partial longitudinal section through the sealing device according to FIG. 6, having a lowered sealing strip, from a second side;

FIG. 13 shows a perspective illustration of part of the sealing device according to FIG. 11;

FIG. 14 shows a perspective illustration of part of the sealing device according to FIG. 12;

FIG. 15 shows a perspective illustration of a contact module according to the invention, according to a first embodiment; and

FIG. 16 shows a perspective illustration of a contact module according to the invention, according to a second embodiment.

### DESCRIPTION OF PREFERRED EMBODIMENTS

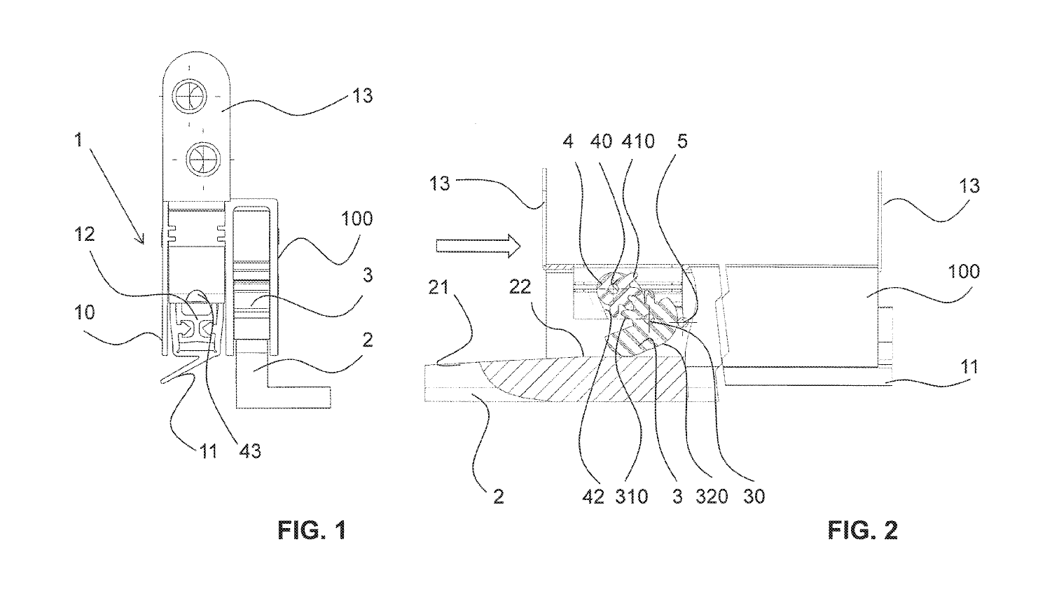

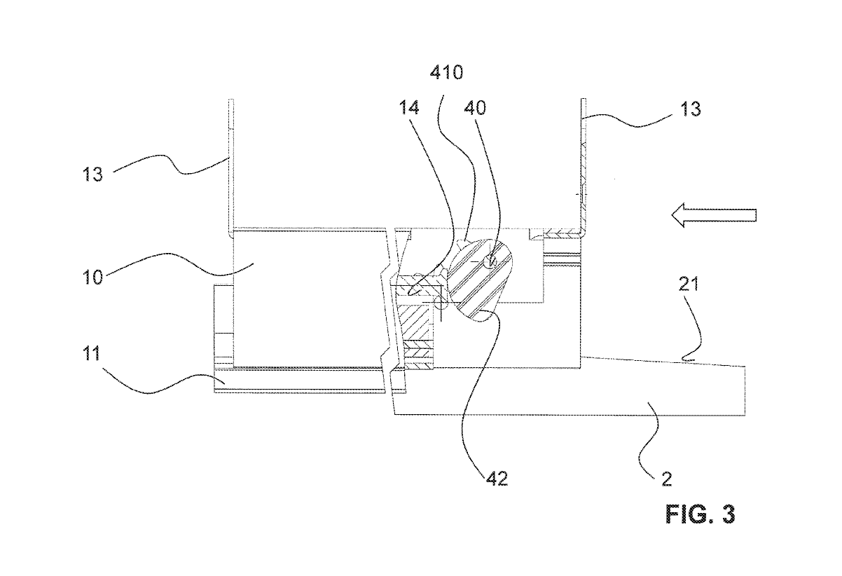

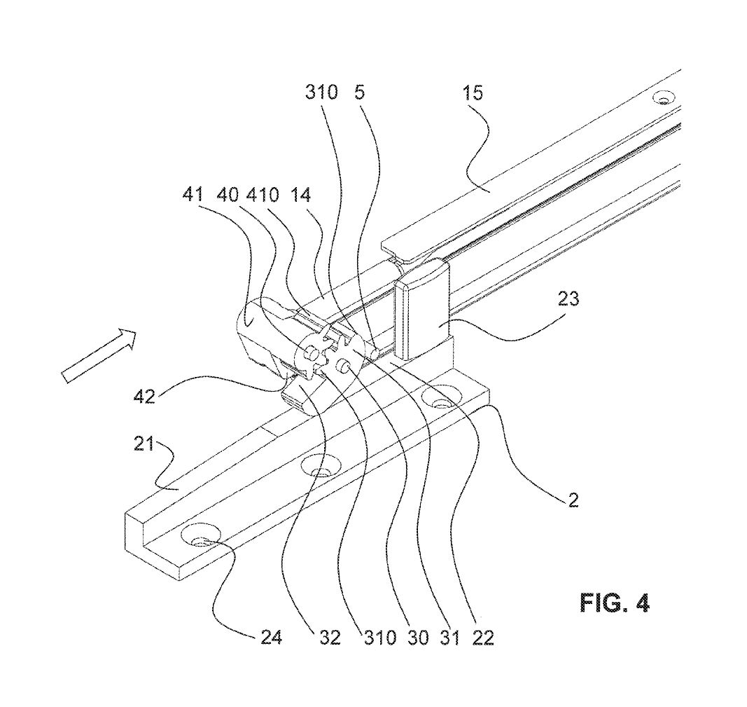

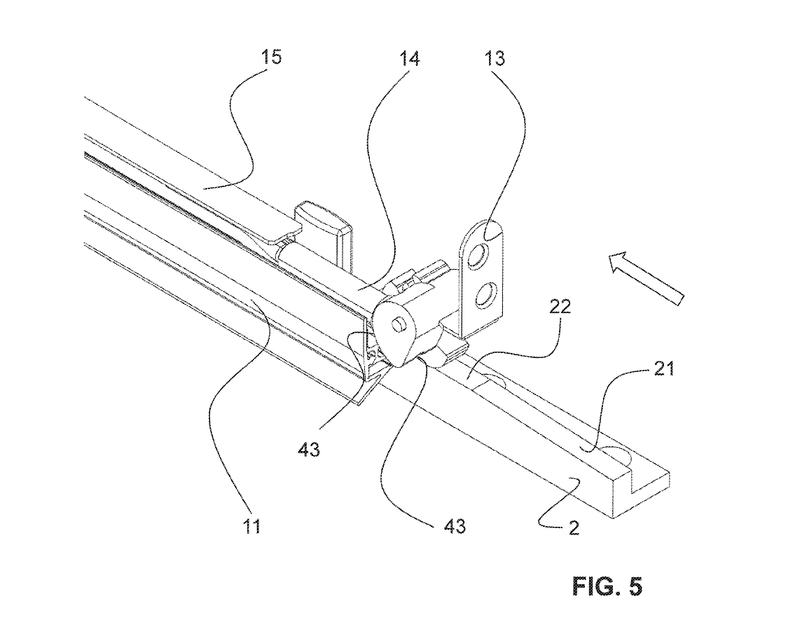

A first exemplary embodiment of a sealing device according to the invention is illustrated in FIGS. 1 to 5. For improved clarity of the images, a few elements such as, for example, the housing rail 10 and the additional wall 100, are not illustrated in FIGS. 4 and 5.

The sealing device has a drop-down seal 1 of a known type, such as has been described at the outset, for example. The drop-down seal 1 has a housing rail 10 which by means of known means, here by means of a fastening angle 13 that at the end side is push-fitted into a groove of the housing rail 10, is fastened in a lower groove of a displaceable sliding door leaf. Other types of fastenings, for example by means of lateral clamps, are likewise possible.

As opposed to the prior art, the housing rail 10 is not only configured in a hat-shaped or U-shaped manner while configuring a first chamber that is open toward the bottom. Said housing rail 10 preferably has a second chamber which is delimited by an external additional wall 100. A sealing strip is held so as to be lowerable and liftable in the first chamber. To this end, a mechanical activation mechanism of a known type that is likewise disposed in the first chamber is present. Said mechanical activation mechanism is often also referred to as a lowering mechanism. Said lowering mechanism is not illustrated here, but is known from the prior art. Said lowering mechanism preferably has one or a plurality of leaf springs, wherein each of the leaf springs is fastened to the housing 10, to the sealing strip, as well as to a slide 15. The slide 15 is connected to an activation button 14 which is disposed on at least one side, preferably only on one side, of the housing rail 10. Said activation button 10 can project from the housing rail 10, be flush with the end side of the latter, or be disposed so as to be set back. If the activation button is disposed within the housing 10, said activation button can be displaced by compression or traction. However, said activation button can also be contacted and moved, for example, by way of a lateral or upper window in the housing rail 10. Trigger mechanisms as an alternative to the activation button can likewise be used in the sealing device according to the invention. The inventive teaching can also be implemented without a second chamber of this type and without an additional wall 100.

The sealing strip preferably has a support rail 12 and an elastomeric sealing profile 11 that is fastened to said support rail 12. The housing rail 10 and the support rail 12 are preferably composed of aluminum or another suitable metal. The sealing profile 11 is preferably made from rubber or silicone.

The sealing profile 11 in the lowered state of the sealing strip seals a gap between the lower side of the door leaf and a floor.

The sealing device according to the invention furthermore comprises an activation unit for activating the activation mechanism of the drop-down seal. The activation unit preferably acts on the activation button 14 of the drop-down seal in that said activation unit preferably depresses said activation button 14. Depending on the activation unit and on the activation mechanism, said activation unit can also displace or extract the button in order for the sealing strip to be lowered.

As can be seen in FIG. 2, the activation unit has a contact module 2 which here is configured as a bearing module. This contact module 2 is disposed beside the drop-down seal 1. Said contact module 2 is preferably fastened in a locationally fixed manner on the floor B or to a housing wall or to the door frame. The through holes existing therefor are provided with the reference sign 24. Said contact module 2 can also be fastened in another way, for example by latching into a C-rail that is open toward the top.

The contact module 2 is located beside the drop-down seal 1, wherein the former in the displacement of the door leaf is received into the second chamber formed by the additional wall 100 of the housing rail 10.

The contact module 2 in this example is configured as an angular element, wherein said contact module 2 by way of one leg is fastened to the floor or the door frame, the second leg protruding upward. The contact module 2 has an upwardly directed first contact face. The first contact face here is configured as a bearing face. Said first contact face in this example has an oblique face 21 and a horizontal face 22 adjacent thereto. The contact module 2 furthermore has an upwardly protruding guide cam 23 which in the closing of the door leaf is guided into the second intermediate space between the additional wall 100 and the housing rail 10.

The contact module 2 is preferably composed of plastics material, metal, or of a coated metal or wood.

The activation unit furthermore comprises a force transmission module which conjointly with the drop-down seal is disposed on the displaceable door leaf. Said force transmission module comprises a contact element 3 and a force transmission element 4, both being pivotable in each case about one axis 30, 40, respectively. The axes 30, 40 are held in the housing 10, 100 of the drop-down seal. The housing rail in the region of this force transmission module preferably has a through window into the second chamber.

The first axis 30 of the contact element 3 and the second axis 40 of the force transmission element 4 are disposed so as to be preferably perpendicular to the longitudinal direction of the drop-down seal and preferably perpendicular to the lowering direction of the sealing strip. Said first axis 30 and said second axis 40 run so as to be mutually parallel and mutually offset. The first axis 30 and/or the second axis 40, in particular in relation to the contact faces 320, 420, thereof, are/is disposed so as to be eccentric in the respective element 3, 4.

The contact element 3 has a main body 31 as well as a contacting arm 32 that is disposed thereon, said contacting arm 32 extending the contact element 3 in terms of length. The contacting arm 32 preferably extends in the same plane as the main body 31.

The contact element 3 is preferably made so as to be integral and preferably of plastics material or metal.

An external jacket portion of the contacting arm 32, conjointly with an external jacket portion of the main body 31, forms a second contact face 320 which is configured so as to be consistent and preferably forms an involute. The second contact face 320 preferably has a curvature radius that varies across the length of said contact face 320. Depending on the embodiment, planar regions are also possible, wherein a curvature that is present across the entire length of the second contact face 320 is preferable.

The main body 31 has a few teeth 310 of a gear wheel. Said teeth 310 mesh with teeth 410 of the force transmission element 4. The latter teeth 410 are molded to a main body 41 of the force transmission element 4. The force transmission element 4 is preferably also made so as to be integral and preferably of plastics material or metal. Said force transmission element 4 has a force transmission arm 42 which forms an extension in terms of length of the main body 41 but in the direction of the second axis 40 is disposed so as to be offset to said main body 41. Said force transmission arm 42 has a third contact face 420 which is directed toward the activation button 14 and contacts the latter in the closing of the door leaf. Said third contact face 420 can be configured so as to be planar. However, said third contact face 420 is preferably configured so as to be likewise curved.

As can be readily seen in FIGS. 2 and 4, the teeth 310, 410 of the contacting element 3 and of the force transmission element 4 are aligned such that the teeth 410 of the force transmission element 4 are aligned in the closing direction of the door leaf, and the teeth 310 of the contacting element 3 are aligned in a manner opposite thereto. The closing direction of the door leaf is indicated by an arrow in the figures.

The functional mode of this sealing assembly can be readily seen by means of FIGS. 2 to 4. In the closing of the door leaf the latter slides across the locationally fixed contact module 2 which is disposed in a locationally fixed manner on the secondary closing edge. The guide cam 23 herein serves as a guide of the displaceable door leaf. The force transmission module 3, 4 reaches the contact module 2 shortly before the door leaf closes. The contact element 3 by way of the contacting arm 32 thereof, and more specifically by way of the second contact face 320 thereof, bears on the first contact face, that is to say initially bears on the oblique face 21 and then on the horizontal face 22. Said contact element 3 bears on said first contact face, wherein the contact element 3 in the closing of the door leaf moves in a sliding manner on the contact module 2, wherein said contact element 3 on account of the movement along the oblique face 21 rotates about the first axis 20.

The force transmission element 4, thanks to the denticulation, is rotated on account of the contact element 3 pivoting about the first axis 30. The force transmission arm 42 is pushed against the activation button 14 and presses the latter into the seal. This is the activation of the activation mechanism of the seal. The leaf springs are tensioned and the sealing strip is lowered.

The contact element 3 slides on the horizontal face 22 preferably without any further pivoting movement so that no further transmission of force to the lowering mechanism takes place.

The lowering is thus performed during the movement on the oblique face 21. Once the horizontal face 22 has been reached the door leaf, depending on the configuration, can indeed still be displaced, the seal however has already been lowered.

The contact element 3 by way of the contacting arm 32 bears on the horizontal face 22. Since the force vector is at an angle of 90°, this prevents the restoring force of the activation button 14 from being able to push open the door leaf again.

Thanks to the eccentric arrangement of the first and/or the second axis and to the shape of the second contact face 320 of the contact element 3, it is achieved that the button 14 in the closing of the door leaf is initially displaced across a small distance and the distance by way of which the button 14 is depressed in the continuing closing increases in comparison to the closing distance of the displaceable door leaf.

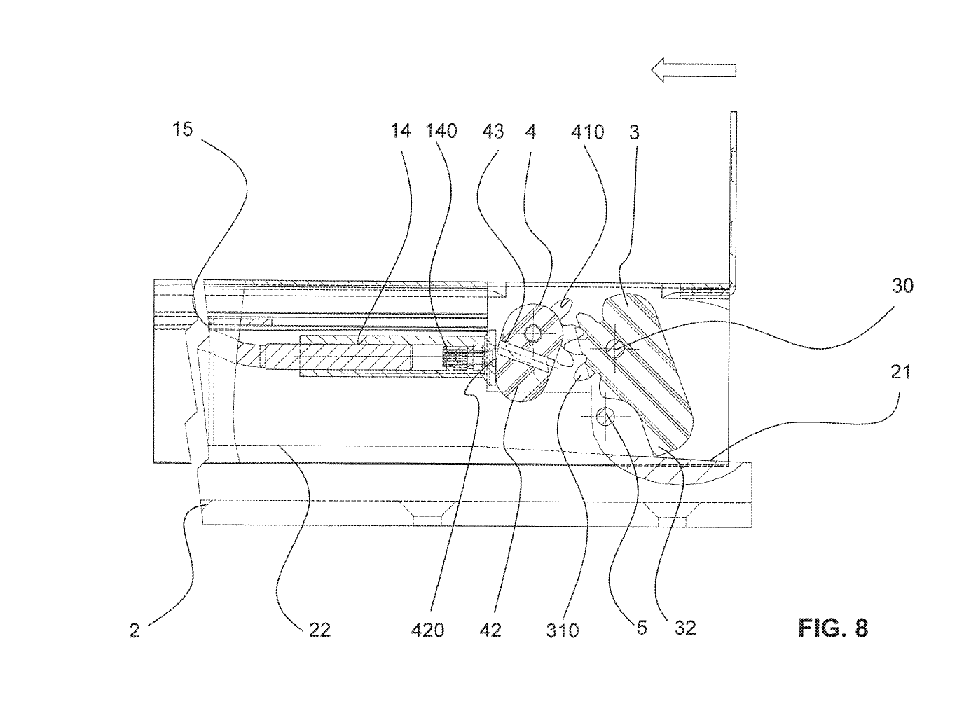

The force transmission module 3, 4 is at least in part disposed at the end side ahead of the drop-down seal. In order for the usual settings such as, for example, the setting of the stroke, to be able to be performed on the drop-down seal the force transmission element 3 has a through opening 43. Said through opening 43 can be readily seen in FIGS. 5 and 8.

Moreover, a stop 5, here in the form of a pin, is present in the region of the contacting element 3. The contacting element 3 can be pivoted to a position up to the former bearing on said stop. This can be readily seen in FIG. 8. The through opening 43 of the force transmission element 4 in this position is horizontally aligned and forms a passage to a thread 140 of the activation button 14. By way of a corresponding tool, for example an Allen key, the through opening 43 can now be penetrated, and the basic position of the activation button 14 in the longitudinal direction can be set in a known manner by being correspondingly rotated, wherein the elements of the force transmission module are held in their position so as to be almost without play, thanks to the stop 5.

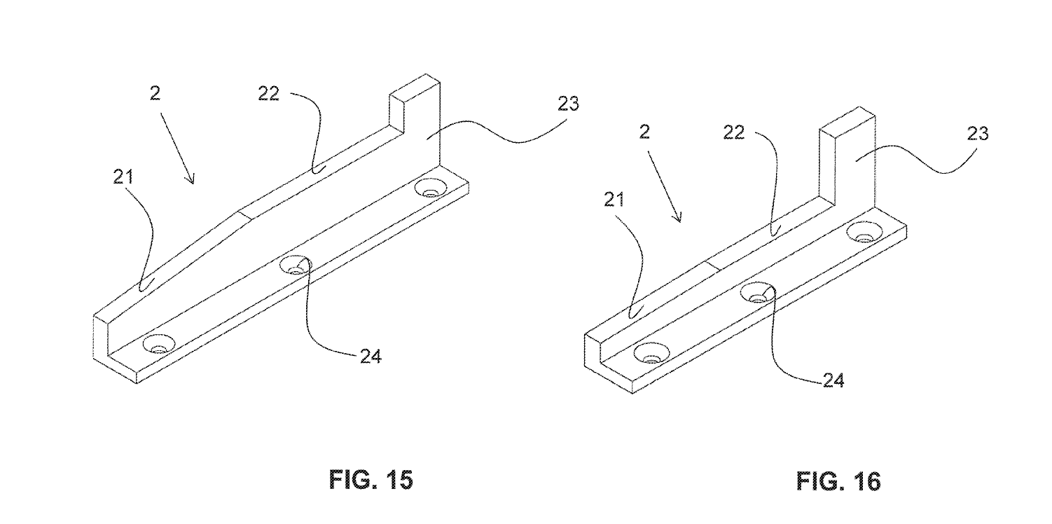

A further setting can be achieved in that the height of the contact module 2 and/or the gradient of the oblique face 21 are/is modified. This can be achieved, for example, in that a set of dissimilarly shaped contact modules 2 having a drop-down seal is offered. A set of this type, composed of two elements 2, is illustrated in FIGS. 15 and 16.

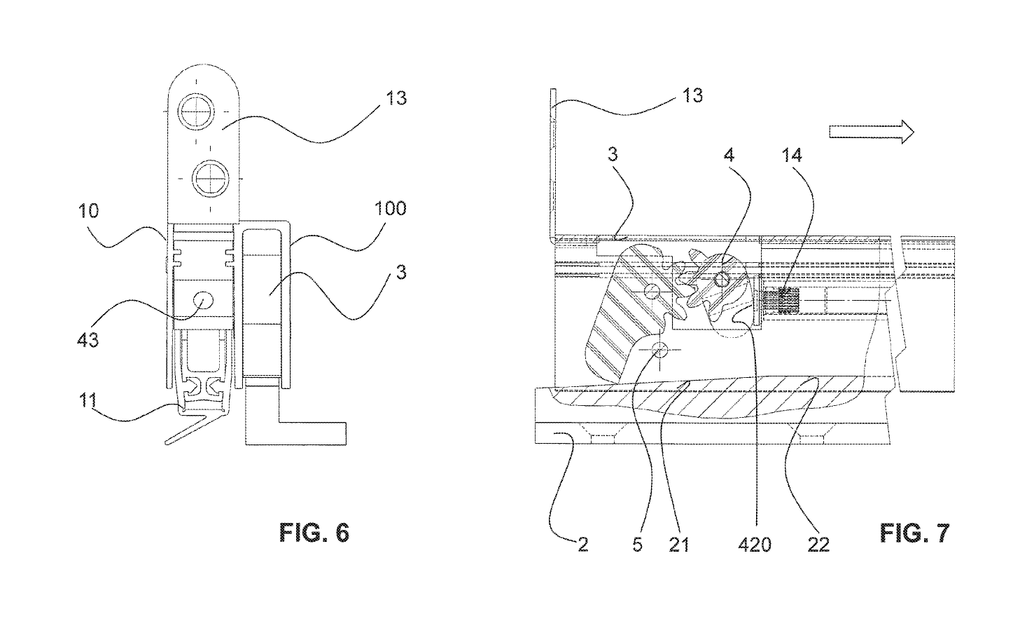

These sets can also be used with the second exemplary embodiment which is described hereunder and is illustrated in FIGS. 6 to 14.

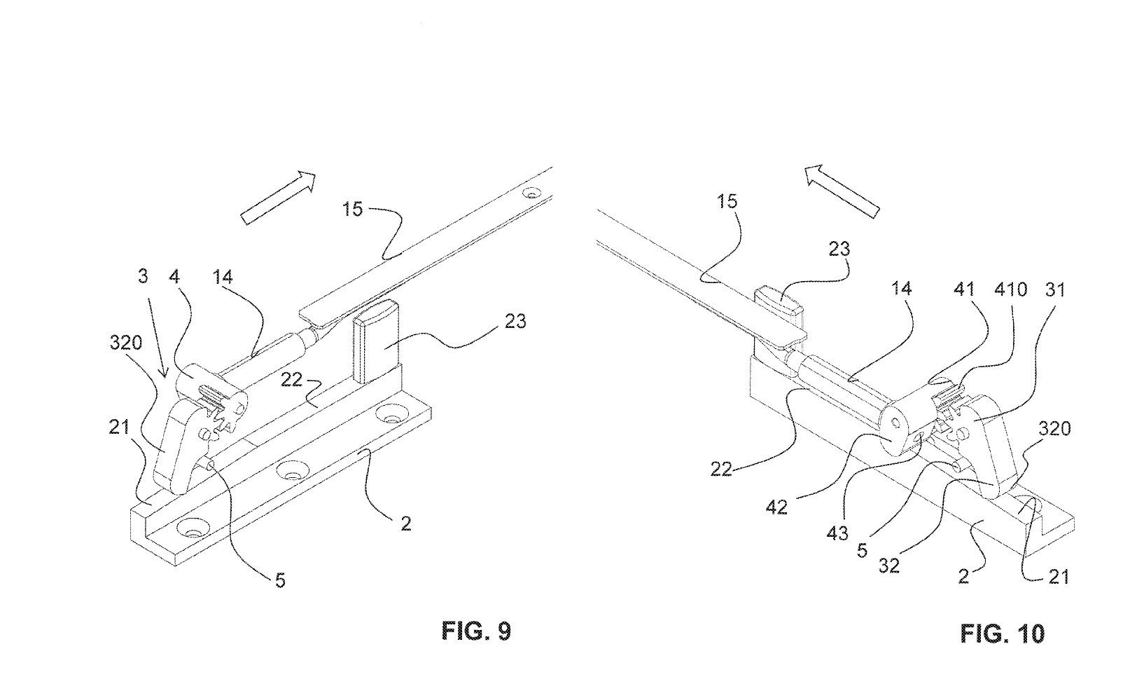

The individual elements correspond to the elements of the first exemplary embodiment and are therefore not explained in detail any more. Identical parts are provided with the same reference signs. However, the assembly of the contact element 3 or of the teeth 310 thereof, respectively, as well as of the force transmission element 4 or of the teeth 410 thereof, respectively, is different. In this example, the teeth 310 of the contact element 3 in the closing direction of the displaceable door leaf are located ahead of the teeth of the force transmission element 4 and terminate in the closing direction. The contact element 3 in the closing direction is thus located behind the force transmission element 4. The gear wheel of this assembly is thus better protected toward the outside since said gear wheel is obscured by the force transmission element 3, in particular by the contacting arm 32. As can be readily seen in FIGS. 9 and 10, the stop 5 is again present but is disposed on another suitable location.

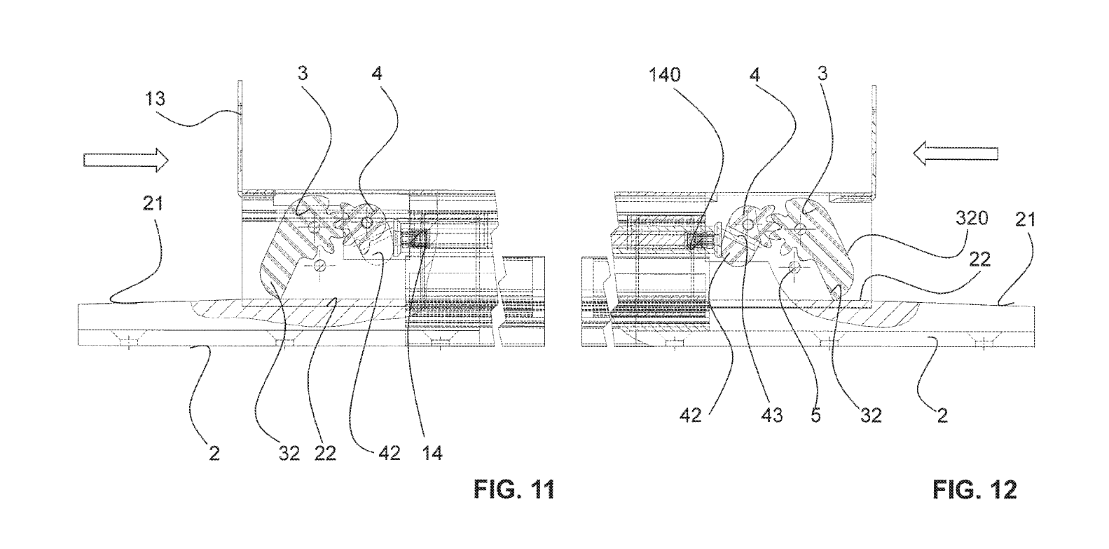

FIGS. 7 to 9 show the situation in the case of a still partially open door leaf and of a sealing strip that has not yet been lowered; FIGS. 11 to 14 show the situation in the case of a closed door leaf and of a lowered sealing strip. The force transmission module 3, 4 in FIG. 6 is pivoted in such a manner that the through opening 43 is moved to the horizontal setting position.

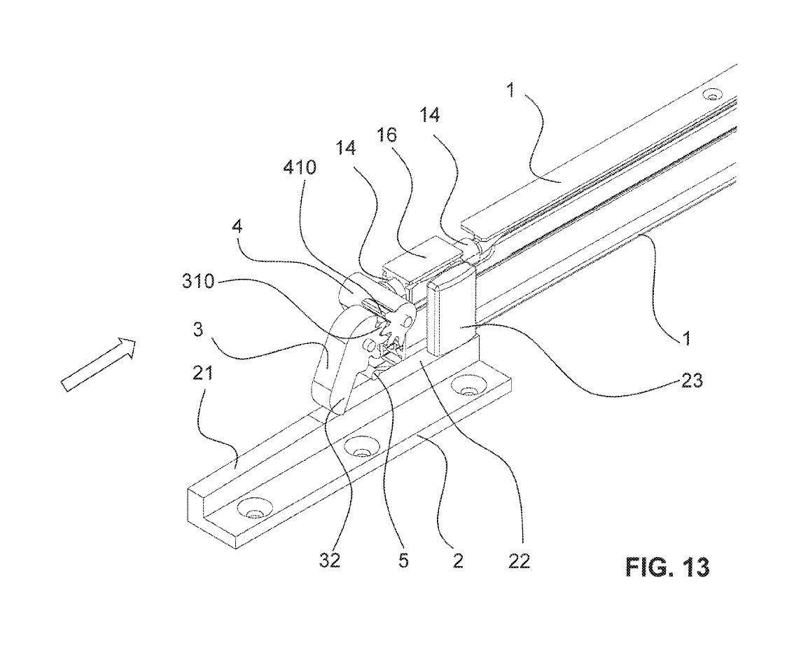

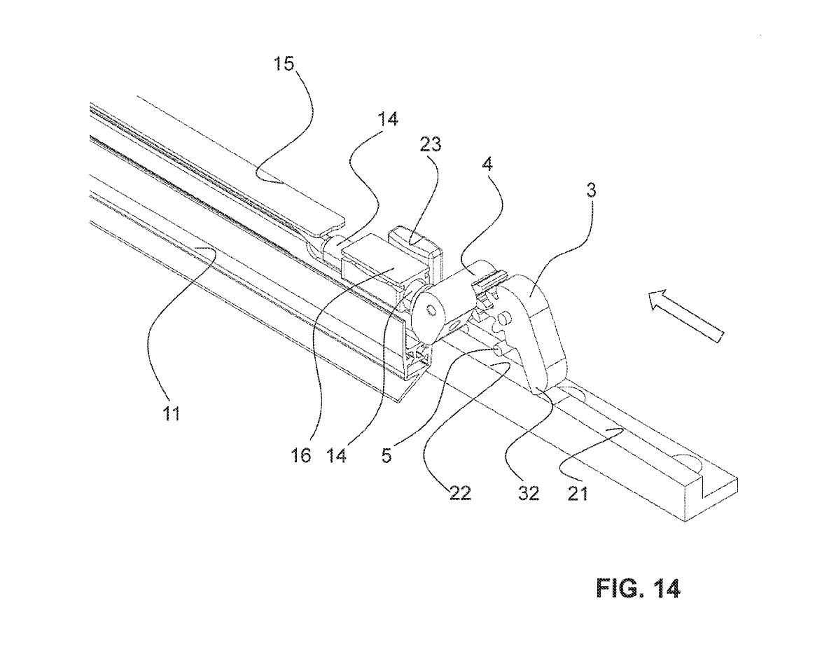

Furthermore, a guide sleeve 16 which surrounds the activation button 14 across at least part of the length of the latter and which is fixed to the housing rail 10 can be readily seen in FIGS. 13 and 14. This guide rail 16 guarantees that the activation button 14, despite the vertical proportions of force acting on said activation button 14 from the pivoted force transmission arm, is displaced only in the longitudinal direction of the drop-down seal. This guide sleeve 16 can also be used in the first exemplary embodiment and in further examples which are not described in detail here.

The device according to the invention enables a robust sealing device for sliding doors that is of comparatively simple construction yet nevertheless extremely effective, wherein the effort in terms of force for lowering the seal is minimized and the sliding door is held in the closed position thereof even in an unlocked position.

### LIST OF REFERENCE SIGNS

| | |
|---|---|
| 1 | Drop-down seal |
| 10 | Housing rail |
| 100 | Additional wall |
| 11 | Sealing profile |
| 12 | Support rail |
| 13 | Fastening angle |
| 14 | Activation button |
| 140 | Thread |
| 15 | Slide |
| 16 | Guide sleeve |
| 2 | Contact module |
| 21 | Oblique face |
| 22 | Horizontal face |
| 23 | Guide cam |
| 24 | Through hole |
| 3 | Contact element |
| 30 | First axis |
| 31 | Main body |
| 310 | Tooth |
| 32 | Contacting arm |
| 320 | Second contact face |
| 4 | Force transmission element |
| 40 | Second axis |
| 41 | Main body |
| 410 | Tooth |
| 42 | Force transmission arm |
| 420 | Third contact face |
| 43 | Through opening |
| 5 | Stop |

1. A sealing device of a sliding door having a displaceably mounted door leaf, the sealing device comprising:
a drop-down seal having a sealing strip and
an activation mechanism for automatically lowering and lifting the sealing strip,
wherein lowering is performed counter to a restoring force,
wherein the sealing device has an activation unit for activating the drop-down seal,
wherein the activation unit has a first contact face, a pivotably configured contact element, and a pivotably configured force transmission element,
wherein the contact element, in closing of the door leaf, contacts the first contact face and, in the closing movement of the door leaf, moves along the first contact face while pivoting the contact element, and
wherein a pivoting movement of the contact element results in a pivoting movement of the force transmission element, on, account of which the force transmission element activates the drop-down seal.

2. The sealing device as claimed in claim 1, wherein the contact element is pivotable about a first axis and the force transmission element is pivotable about a second axis.

3. The sealing device as claimed in claim 2, wherein the first axis is disposed so as to be perpendicular to a longitudinal direction of the drop-down seal and perpendicular to a lowering direction of the sealing strip, and wherein the second axis runs so as to be parallel with the first axis.

4. The sealing device as claimed in claim 1, wherein the contact element has a second contact face which in the closing movement of the door leaf moves along the first contact face while pivoting the contact element, and wherein at least one of the second contact face and the first contact face is configured so as to be curved.

5. The sealing device as claimed in claim 1, wherein the first contact face is directed upward and the contact element in the closing of the door leaf bears on said first contact face and moves along the first contact face and on account thereof activates the drop-down seal.

6. The sealing device as claimed in claim 1, wherein the first contact face, in a direction of the closing movement, has a first region which is configured as an oblique face.

7. The sealing device as claimed in claim 6, wherein the first contact face has a horizontally running region that follows the oblique face.

8. The sealing device as claimed in claim 1, wherein the force transmission element activates the activation mechanism in order for the sealing strip to be lowered.

9. The sealing device as claimed in claim 1, wherein the contact element and the force transmission element mesh with one another.

10. The sealing device as claimed in claim 1, wherein the force transmission element, in the closing of the door leaf, activates an activation button of the activation mechanism.

11. The sealing device as claimed in claim 1, wherein the force transmission element has a main body and a force transmission arm that is laterally offset in relation to the main body, wherein the force transmission arm activates the activation mechanism.

12. The sealing device as claimed in claim 11, wherein the force transmission arm has a curved third contact face.

13. The sealing device as claimed in claim 1, wherein the contact element has a main body and a contacting arm disposed thereon, and wherein a free end of the contacting arm in the closing of the sliding door first contacts the first contact face.

14. The sealing device as claimed in claim 1, wherein the main bodies of the contact element and of the force transmission element, at least across part of the circumference thereof, are configured as gear wheels.

15. The sealing device as claimed in claim 1, wherein the contact element is fixedly connected to the drop-down seal, and the first contact face is configured in a module which is separate from the drop-down seal and which is intended for disposal in a locationally fixed part of the sliding door.

16. A sealing device of a sliding door having a displaceably mounted door leaf, the sealing device comprising:
a drop-down seal having a sealing strip and
an activation mechanism for automatically lowering and lifting the sealing strip,
wherein lowering is performed counter to a restoring force,
wherein the sealing device has an activation unit for activating the drop-down seal,
wherein the activation unit has a contact element which, in the closing of the door leaf, contacts a first contact face of the activation unit and, on account thereof, activates the drop-down seal,
wherein the activation unit has a force transmission element,
wherein the contact element is configured so as to be pivotable about a first axis, and the force transmission element is configured so as to be pivotable about a second axis,
wherein the contact element and the force transmission element mesh with one another such that, in the closing of the door leaf, a pivoting movement of the contact element about the first axis results in a pivoting movement of the force transmission element about the second axis, and
wherein the force transmission element, in the closing of the door leaf by way of the pivoting movement of said force transmission element, activates the drop-down seal.

17. A sealing device of a sliding door having a displaceably mounted door leaf, the sealing device comprising:
a drop-down seal having a sealing strip and
an activation mechanism for automatically lowering and lifting the sealing strip,
wherein lowering is performed counter to a restoring force, and wherein the sealing device has an activation unit for activating the drop-down seal,
wherein the activation unit has a contact element which, in the closing of the door leaf, contacts a first contact face of the activation unit and, on account thereof, activates the drop-down seal,
wherein the activation unit has a pivotable force transmission element which is operatively connected to the contact element, and
wherein the force transmission element has a curved contact face which, in the closing of the door leaf, activates an activation button of the activation mechanism in order for the sealing strip to be lowered.

18. A sealing device of a sliding door having a displaceably mounted door leaf, the sealing device comprising:
a drop-down seal having a sealing strip and
an activation mechanism for automatically lowering and lifting the sealing strip,
wherein lowering is performed counter to a restoring force,
wherein the sealing device has an activation unit for activating the drop-down seal,
wherein the activation unit has a contact element which, in the closing of the door leaf, contacts a first contact face of the activation unit and, on account thereof, activates the drop-down seal,
wherein the contact element is configured so as to be pivotable about a first axis and has a second contact face which, in the closing movement of the door leaf, moves along the first contact face while pivoting the contact element,
and
wherein at least one of the second contact face and the first contact face is configured so as to be curved.
